(19) United States
(12) Patent Application Publication
(10) Pub. No.: US 2026/0155088 A1
(43) Pub. Date: Jun. 4, 2026

(54) DISPLAY DEVICE AND DISPLAY DEVICE CONTROL METHOD

(71) Applicant: Sharp Display Technology Corporation, Kameyama City, Mie (JP)

(72) Inventors: Kazuki TAKAHASHI, Kameyama City, Mie (JP); Tatsuhiko SUYAMA, Kameyama City, Mie (JP); Kazuo NAKAMURA, Kameyama City, Mie (JP); Noriyuki TANAKA, Kameyama City, Mie (JP)

(21) Appl. No.: 19/122,378

(22) PCT Filed: Oct. 26, 2022
(86) PCT No.: PCT/JP2022/039850

§ 371 Date: Apr. 18, 2025

(51) Int. Cl. G09G 3/32; G06F 3/01

(52) U.S. Cl. CPC G09G 3/32; G06F 3/013; G09G 2320/0257; G09G 2340/0464; G09G 2354/00

(57) ABSTRACT

A display device includes a display panel including a plurality of self-light-emitting elements a display control unit for controlling display of an image by the display panel, and a viewing sensor. The viewing sensor detects, from a state of the user, a non-viewing state that is a state in which a state in which the user does not view the display screen, a state in which a line of sight of the user does not intersect the display screen, or a state in which a distance between a viewpoint of the user on the display screen and a position of the image is equal to or greater than a predetermined value. The display control unit changes a display position of at least part of the image by the display panel through control of light emission of the plurality of self-light-emitting elements when the viewing sensor detects the non-viewing state.

### TECHNICAL FIELD

The disclosure relates to a display device including a plurality of self-light-emitting elements, and to a control method of the display device.

### BACKGROUND ART

In a display device including a self-light-emitting element, causing the same self-light-emitting element to emit light for a long time, such as displaying the same image for a long time, leads to image sticking of the display device due to deterioration of the self-light-emitting element. Thus, a technique for reducing the image sticking has been proposed. PTL 1 discloses an organic light-emitting display device that suppresses visibility of the image sticking by moving a display position of an image on a panel at predetermined time intervals.

CITATION LIST

### Patent Literature

PTL 1: JP 2007-304318 A

### SUMMARY

### Technical Problem

In the display described in PTL 1, when a display position of an image moves in a state in which a user views the image, a user may perceive the movement of the display position of the image, and viewability of the image by the user may be deteriorated.

### Solution to Problem

A display device according to an embodiment of the disclosure includes a display panel including a plurality of self-light-emitting elements, a display control unit for individually controlling light emission of the plurality of self-light-emitting elements to control display of an image on the display panel, and a viewing sensor for detecting, from a state of a user, a non-viewing state that is a state in which the user does not view a display screen, a state in which a line of sight of the user does not intersect the display screen, or a state in which a distance between a viewpoint of the user on the display screen and a position of the image is equal to or greater than a predetermined value, in which the display control unit changes a display position of at least part of the image on the display panel through control of light emission of the plurality of self-light-emitting elements when the viewing sensor detects the non-viewing state.

A control method of a display device according to an embodiment of the disclosure is a control method of a display device including a display panel including a plurality of self-light-emitting elements, and the control method includes control of display of an image on the display panel through individual control of light emission of the plurality of self-light-emitting elements, detection, based on a state of a user, of a non-viewing state that is a state in which the user does not view a display screen, a state in which a line of sight of the user does not intersect the display screen, or a state in which a distance between a viewpoint of the user on the display screen and a position of the image is equal to or greater than a predetermined value; and change of a display position of at least part of the image on the display panel through control of light emission of the plurality of self-light-emitting elements when the non-viewing state is detected.

### Advantageous Effects of Disclosure

Image sticking of a self-light-emitting element can be reduced while suppressing deterioration of viewability of an image by a user.

### BRIEF DESCRIPTION OF DRAWINGS

FIG. 1 is a schematic plan view of a display device according to a first embodiment.

FIG. 2 is a flowchart illustrating an example of a control method of the display device according to the first embodiment.

FIG. 3 is a schematic view of a display portion illustrating an example of a display position of an image in the display portion according to the first embodiment.

FIG. 4 is a flowchart illustrating an example of a control method of a display device according to a second embodiment.

FIG. 5 is a flowchart illustrating an example of a control method of a display device according to a third embodiment.

FIG. 6 is a schematic view of a display portion illustrating an example of a display position of an image in the display portion according to the third embodiment.

FIG. 7 is a flowchart illustrating an example of a control method of a display device according to a fourth embodiment.

FIG. 8 is a flowchart illustrating an example of a control method of a display device according to a fifth embodiment.

### DESCRIPTION OF EMBODIMENTS

### First Embodiment

### Display Device

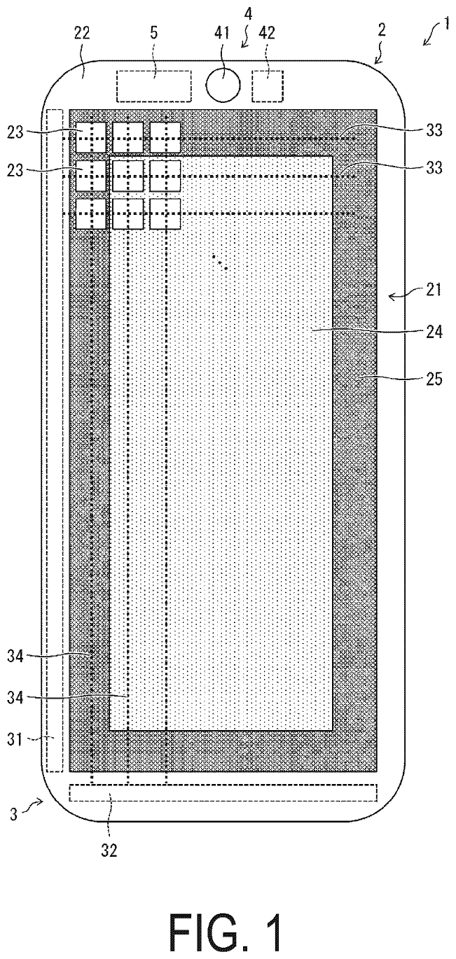

FIG. 1 is a schematic plan view of a display device according to a first embodiment. As illustrated in FIG. 1, a display device 1 includes a display panel 2, a display control unit 3, a viewing sensor 4, and a control unit 5.

The display panel 2 includes, for example, a display portion 21 having a rectangular shape and forming a display screen of the display panel 2 and a frame portion 22 formed at a periphery of the display portion 21 in a plan view of the display panel 2. The display panel 2 includes a plurality of self-light-emitting elements 23 in the display portion 21 so as to be aligned in a vertical direction and a horizontal direction of the display device 1 in a plan view. In FIG. 1, the self-light-emitting elements 23 are illustrated in a transparent manner.

The self-light-emitting elements 23 are individually controlled to emit light by the display control unit 3 described later. The self-light-emitting element 23 is formed on a substrate (not illustrated), for example, and emits light to a side opposite to the substrate by light emission control by the display control unit 3. Thus, the display device 1 causes the self-light-emitting elements 23 to individually emit light by the display control unit 3 to implement display on the display panel 2. The self-light-emitting element 23 may be an OLED element containing an organic material as a light-emitting material, a QLED element containing quantum dots as the light-emitting material, or the like.

The display control unit 3 includes, for example, a first driver 31 and a second driver 32 each located in the frame portion 22. For example, the first driver 31 individually applies a signal to a respective one of a plurality of first signal lines 33 each extending in the horizontal direction in a plan view of the display panel 2. The second driver 32 individually applies a signal to a respective one of a plurality of second signal lines 34 each extending in the vertical direction in a plan view of the display panel 2.

For example, a drive circuit (not illustrated) is formed at each of the intersections of the first signal lines 33 and the second signal lines 34 on the substrate, and each drive circuit is electrically connected to the corresponding self-light-emitting element. Thus, the display control unit 3 individually controls the drive circuits through the application of image signals to the signal lines by the first driver 31 and the second driver 32, and thus individually controls the light emission of the self-light-emitting elements 23.

For example, the display control unit 3 controls the light emission of some of the plurality of self-light-emitting elements 23 and controls display of an image 24 on the display panel 2. On the other hand, the display control unit 3 does not cause some of the other plurality of self-light-emitting elements 23 to emit light. Thus, part of a region in a plan view of the display panel 2 is a black display region 25. The display control unit 3 controls the display position of the image 24 through the control of a position of the black display region 25 in a plan view of the display panel 2 by controlling a position of the self-light-emitting element 23 to be caused to emit light.

The viewing sensor 4 detects a viewing state by the user of the image 24 displayed by the display panel 2 from a state of the user of the display device 1. In particular, the viewing sensor 4 detects a non-viewing state from the state of the user.

In the disclosure, the non-viewing state refers to a state in which the user does not view the image 24 or a state in which a degree of viewing the image 24 by the user is low. The state in which the degree of viewing the image 24 by the user is low is a state in which a line of sight of the user does not intersect the display portion 21 which is the display screen or a state in which a distance between a viewpoint of the user on the display portion 21 and a position of the image 24 is equal to or greater than a predetermined value.

For example, when the distance between a point at which the line of sight of the user intersects the display portion 21 or an extension plane of the display portion 21 and the position of the image 24 is equal to or greater than the predetermined value, the image 24 is not present in a field of view of the user or the image 24 is present only at an end of the field of view of the user. Thus, a state in which the line of sight of the user does not intersect the display portion 21 which is the display screen and a state in which the distance between the viewpoint of the user on the display portion 21 and the position of the image 24 is equal to or greater than a predetermined value can be regarded as the non-viewing state in which the degree of viewing the image 24 by the user is low.

In particular, in the disclosure, the non-viewing state in which the user does not view the image 24 includes, for example, a state in which the user does not view the image 24 because an eyelid of the user is closed due to blinking or the like of the user. The non-viewing state in which the degree of viewing the image 24 by the user is low includes, for example, a state in which the viewpoint of the user is located at a periphery of the image 24, in other words, the line of sight of the user does not intersect the image 24.

The viewing sensor 4 includes, for example, a camera 41 formed on a display surface side of the display panel 2 of the frame portion 22, and a captured image analysis unit 42 formed inside the frame portion 22. The camera 41 captures the user by capturing the display surface side of the display panel 2. The camera 41 may be a self-camera mounted on the display device 1 in order to capture a photographer himself/herself using the camera 41. The captured image analysis unit 42 analyzes the captured image obtained by the camera 41 to detect the viewing state of the image 24 by the user from the captured image, thereby detecting the above-described non-viewing state. The viewing sensor 4 is not limited to this, and may be various sensors known in the related art, such as a sensor such as a viewpoint sensor that specifies a direction in which the user views, or a sensor that detects blinking of the user.

For example, the captured image analysis unit 42 may detect the non-viewing state from the captured image obtained by the camera 41 through specification of a position of an iris, a pupil, or the like of an eyeball of the user or opening and closing of the eyelid of the user.

Alternatively, for example, the captured image analysis unit 42 may detect the non-viewing state from the captured image obtained by the camera 41 through specification of directions or the like of a face, a head, or a body of the user. As a specific method of analyzing the captured image by the captured image analysis unit 42, an image analysis method known in the related art may be adopted, and the method is not particularly limited.

The control unit 5 controls operations of the display panel 2, the display control unit 3, and the viewing sensor 4 included in the display device 1. For example, the control unit 5 may be formed in the frame portion 22 of the display panel 2, but the present embodiment is not limited thereto, and the control unit 5 may be located outside a housing of the display device 1. The control unit 5 may include a communication unit (not illustrated) for executing exchange of information with each unit of the display device 1.

### Changing Method of Display Position of Image

The display control unit 3 controls the display position of the image 24 on the display panel 2 based on a result of detection of the viewing state of the image 24 of the user by the viewing sensor 4. In particular, when the viewing sensor 4 detects the non-viewing state, the display control unit 3 changes the display position of at least part of the image 24 on the display panel 2 through control of light emission of the self-light-emitting element 23. In particular, the display control unit 3 may change the display position of at least part of the image 24 by changing a position on the display panel 2 of some of the constituent elements of the image 24 on the display panel 2.

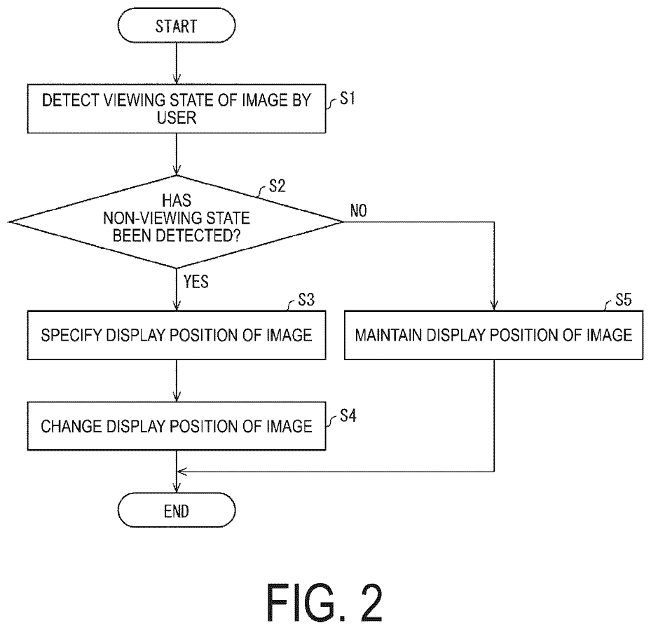

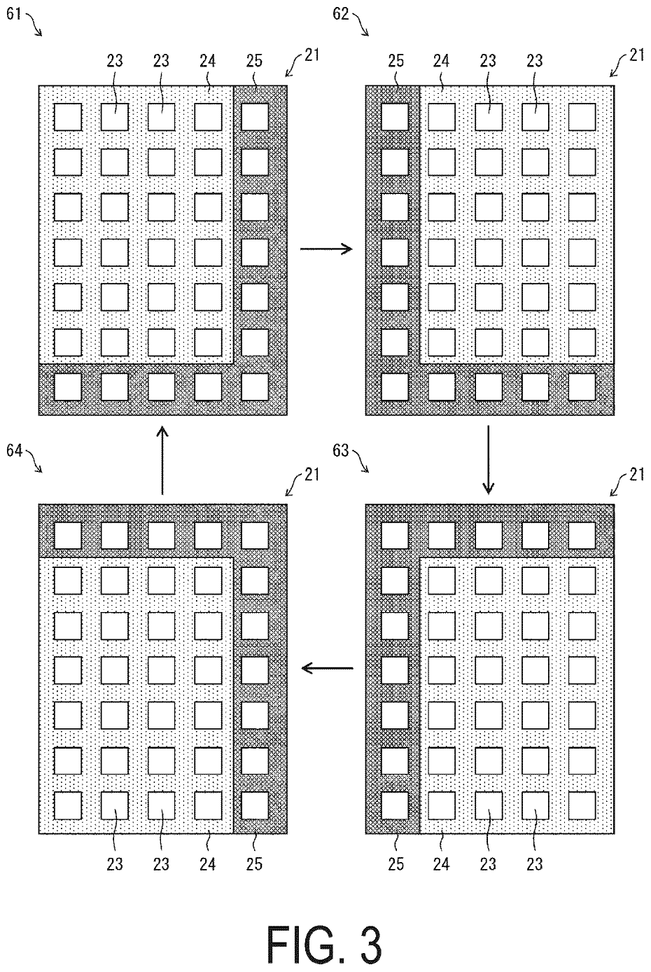

A specific method by which the display control unit 3 changes the display position of the image 24 will be described through the description of an example of a control method of the display device 1 with reference to FIGS. 2 and 3.

FIG. 2 is a flowchart illustrating an example of the control method of the display device 1 according to the present embodiment. In the flowchart illustrating the example of the control method of the display device 1 according to the disclosure including FIG. 2, the method of controlling the display device 1 through control of each unit of the display device 1 by the control unit 5 will be described.

FIG. 3 is a schematic view of the display portion 21 illustrating an example of display on the display panel 2 for illustrating an example of the display position of the image 24 on the display panel 2 according to the present embodiment. FIG. 3 illustrates schematic views of the display portion 21 in a state where the display panel 2 displays the image 24 as illustrated in schematic views 61, 62, 63, and 64 in which the display positions of the image 24 on the display panel 2 are different from each other. The schematic views of the display portion 21 according to the embodiment of the disclosure including FIG. 3 are schematic views of the display portion 21 in a plan view, and illustrate the self-light-emitting element 23 in a transparent manner in the schematic views.

The control method of the display device 1 illustrated in FIG. 2 is constantly and repeatedly executed while the display of the image 24 on the display panel 2 continues. In addition, through the control of the display control unit 3, the control unit 5 causes the display panel 2 to continue the display of the image 24 while the control method of the display device 1 illustrated in FIG. 2 is executed. In other words, the control unit 5 causes the display control unit 3 to individually control the light emission of the self-light-emitting elements 23 and to control the display of the image 24 on the display panel 2. For example, the control method of the display device 1 illustrated in FIG. 2 may be constantly executed during a period from power-on to power-off of the display device 1. For example, the control unit 5 causes the display panel 2 to display a moving picture by continuously changing the content of the image 24 through the control of the display control unit 3 and continuing the display of the image 24 on the display panel 2.

At the start of the control method of the display device 1 according to the present embodiment, it is assumed that the control unit 5 causes the display panel 2 to display the image 24 as illustrated in the schematic view 61 of FIG. 3. In this case, as illustrated in the schematic view 61, the image 24 is displayed at an upper left of the display portion 21, and the black display region 25 is formed at a right end portion and a lower end portion of the display portion 21. In particular, when the display panel 2 displays the image 24 as illustrated in the schematic view 61, one column of the self-light-emitting elements 23 located at the right end portion of the display portion 21 and one row of the self-light-emitting elements 23 located at the lower end portion do not emit light. For example, at the time of power-on of the display device 1, the control unit 5 may cause the display panel 2 to display the image 24 as illustrated in the schematic view 61.

In the control method of the display device 1 according to the present embodiment, first, the control unit 5 causes the viewing sensor 4 to detect the viewing state of the image 24 by the user (step S1). In step S1, for example, through control of the viewing sensor 4, the control unit 5 causes the camera 41 to capture the user, and causes the captured image analysis unit 42 to analyze the captured image obtained by the camera 41.

Subsequently, based on the state of the user detected by the viewing sensor 4 in step S1, the control unit 5 determines whether the viewing sensor 4 has detected the above-described non-viewing state (step S2). In other words, the control unit 5 causes the viewing sensor 4 to execute detection of the non-viewing state based on the state of the user.

If the control unit 5 determines that the viewing sensor has detected the non-viewing state in step S2, then the control unit 5 specifies the display position of the image 24 on the display panel 2 (step S3). Step S3 may be executed by the control unit 5 specifying what kind of display is performed by the display panel 2, for example, may be executed by the control unit 5 specifying a position of a signal line to which an image signal is applied by the display control unit 3.

Subsequent to step S3, the control unit 5 causes the display control unit 3 to change the display position of the image 24 on the display panel 2 based on the display position of the image 24 on the display panel 2 (step S4).

For example, when the display panel 2 executes the display of the image 24 illustrated in the schematic view 61, in step S4, the control unit 5 causes the display panel 2 to display the image 24 as illustrated in the schematic view 62 through the control of the display control unit 3. The change of the display on the display panel 2 by the control unit 5 is executed by, for example, the control unit 5 causing the display control unit 3 to change the self-light-emitting element to be caused not to emit light. In other words, in step S4, the display control unit 3 changes the display position of the image 24 on the display panel 2 through the control of the light emission of the self-light-emitting elements 23.

When the display panel 2 displays the image 24 as illustrated in the schematic view 62, the display panel 2 displays the image 24 at the uppermost right of the display portion 21. Thus, in the schematic view 62, the black display region 25 is formed at a left end portion and the lower end portion of the display portion 21. In other words, when the display panel 2 displays the image 24 as illustrated in the schematic view 62, one column of the self-light-emitting elements 23 located at the left end portion of the display portion 21 and one row of the self-light-emitting elements 23 located at the lower end portion do not emit light. Thus, the control unit 5 changes the display on the display panel 2 from the display illustrated in the schematic view 61 to the display illustrated in the schematic view 62, thereby changing the display position of the image 24 on the display panel 2 from the upper left to an upper right of the display portion 21.

On the other hand, if the control unit 5 determines that the viewing sensor has not detected the non-viewing state in step S2, then the control unit 5 maintains the display position of the image 24 on the display panel 2 (step S5). Step S5 may be executed by the control unit 5 causing the display control unit 3 to maintain the positions of the self-light-emitting elements to be caused not to emit light.

In the present embodiment, subsequent to the execution of step S4 or step 5, the control unit 5 continues to execute step S1. In other words, after the control unit 5 changes or maintains the display position of the image 24 on the display panel 2 in step S4, the control unit 5 causes the viewing sensor 4 to detect the viewing state of the image by the user again. Thus, the control unit 5 repeatedly executes steps S1 to S5.

When the display panel 2 displays the image 24 in step S3 as illustrated in the schematic view 62 according to the present embodiment, the control unit 5 causes the display panel 2 to display the image 24 in step S4 as illustrated in the schematic view 63. In other words, when the image 24 is displayed at the upper right of the display portion 21 in step S3, the control unit 5 changes the display position of the image 24 to the lower right of the display portion 21 in step S4.

Similarly, when the display panel 2 displays the image 24 as illustrated in the schematic view 63 in step S3 according to the present embodiment, the control unit 5 causes the display panel 2 to display the image 24 in step S4 as illustrated in the schematic view 64. In other words, when the image 24 is displayed at the lower right of the display portion 21 in step S3, the control unit 5 changes the display position of the image 24 to the lower left of the display portion 21 in step S4.

Further, when the display panel 2 displays the image 24 as illustrated in the schematic view 64 in step S3 according to the present embodiment, the control unit 5 causes the display panel 2 to display the image 24 in step S4 as illustrated in the schematic view 61. In other words, when the image 24 is displayed at the lower left of the display portion 21 in step S3, the control unit 5 changes the display position of the image 24 on the display panel 2 to the upper left of the display portion 21 in step S4.

As described above, the control unit 5 repeatedly changes the display on the display panel 2 to the display illustrated in each of the schematic views 61, 62, 63, and 64 in this order. Thus, the control unit 5 periodically changes the display position of the image 24 on the display panel 2. Thus, the control unit 5 may record the number of times the non-viewing state is detected in step S2 in a storage unit (not illustrated) or the like. In this case, the control unit 5 may specify the display position of the image 24 on the display panel 2 by reading the number of times in step S3.

At the time of power-off of the display device 1, the control unit 5 may record the display position of the image 24 at that time point in the storage unit (not illustrated). In this case, at the time of power-on of the display device 1, the control unit 5 may cause the display panel 2 to display the image 24 at the display position of the image 24 recorded at the time of last power-off of the display device 1.

### Effects of Display Device

According to the above-described control method of the display device 1, the display position of the image 24 on the display panel 2 is changed by the display control unit 3 every time the viewing sensor 4 detects the above-described non-viewing state. Thus, the display device 1 can equalize total driving times of the respective self-light-emitting elements 23 depending on the positions on the display panel 2 as compared with a case where the image 24 is constantly displayed at the same position on the display panel 2. Thus, the display device 1 can reduce image sticking of the respective self-light-emitting elements 23.

Furthermore, in the present embodiment, the change in the display position of the image 24 on the display panel 2 by the display control unit 3 is executed when the viewing sensor 4 detects the non-viewing state as described above. Thus, the display device 1 changes the display position of the image 24 on the display panel 2 in a state where the user does not view the image 24 or the degree of viewing the image 24 by the user is low. Thus, the display device 1 can change the display position while preventing the user from perceiving the change in the display position of the image 24 on the display panel 2.

Thus, the display device 1 can reduce the image sticking of the self-light-emitting element 23 while suppressing the deterioration of the viewability of the image 24 by the user.

In general, for example, a frame of a window, an icon, or the like of application software is displayed at an end portion of an image. In such display, the position on the display panel is difficult to move, and it is often necessary for the self-light-emitting element to emit light at high luminance for the display. Thus, in the display device 1 including the display panel 2 including the plurality of self-light-emitting elements 23, the self-light-emitting element 23 located at the end portion of the display panel 2 may be faster in a progress of the image sticking than the other self-light-emitting elements 23. The image sticking of the self-light-emitting element 23 located at the end portion of the display panel 2 tends to be more likely to be perceived by the user than the image sticking of the self-light-emitting element 23 located near the center of the display panel 2.

According to the control method of the display device 1 described above, the black display region 25 is located in at least part of the periphery of the image 24 in a plan view of the display panel 2. Thus, the display device 1 can efficiently suppress the progress of the image sticking of the self-light-emitting element 23 located at the peripheral end portion of the display panel 2. Thus, the display device 1 more efficiently prevents the user from perceiving the image sticking of the self-light-emitting element 23.

Also in the self-light-emitting element 23 located in the vicinity of the center of the display portion 21 which is constantly driven to display the image 24, a variation in luminance occurs in accordance with the change in the display position of the image 24. Thus, the display device 1 can prevent the self-light-emitting element 23 from constantly being caused to emit light at high luminance, and can prevent the user from perceiving the image sticking of the self-light-emitting element 23.

The state in which the eyelid of the user is closed occurs relatively frequently due to blinking or the like of the user. The state in which the viewpoint of the user is located at the periphery of the image 24 also relatively frequently occurs due to confirmation of the surroundings of the display device 1 or the like by the user. Thus, by including these states in the non-viewing state, the display device 1 efficiently increases the frequency of the change in the display position of the image 24 on the display panel 2.

According to the control method of the display device 1 described above, in step S4, the display control unit 3 changes the display position of the entire image 24 on the display panel 2. Thus, the display device 1 can prevent a boundary between a moved portion and an unmoved portion of the image 24 from being perceived by the user as compared with the case where the display control unit 3 changes only the display position of part of the image 24 on the display panel 2. Thus, the display device 1 can further reduce the deterioration of the viewability of the image 24 by the user while reducing the image sticking of the self-light-emitting element 23.

The changing method of the display position of the image 24 on the display panel 2 by the display control unit 3 in step S4 is not limited to the above-described example. For example, it is assumed that the display panel 2 displays the image 24 which is black at most positions and can be displayed by causing some of the self-light-emitting elements 23 to emit light. In this case, the display control unit 3 may change only a display position of a portion of the image 24 on the display panel 2 where the self-light-emitting elements 23 need to be caused to emit light for display. For example, when the image 24 is black at the boundary between the moved portion and the unmoved portion of the image 24, even when the display control unit 3 changes only the display position of part of the image 24 on the display panel 2, the boundary is less likely to be perceived by the user.

In the control method of the display device 1 described above, the example is described in which in step S4, the display control unit 3 moves the position of the self-light-emitting element 23 to be caused to emit light by one element in the vertical direction or the horizontal direction of the display panel 2, but the present embodiment is not limited thereto. For example, in step S4, the display control unit 3 may move the position of the self-light-emitting element 23 to be caused to emit light by two or more elements at a time, or may move the position in an oblique direction of the display panel 2.

The display panel 2 may include a plurality of pixels each including a plurality of light-emitting elements of luminescent colors different from each other, the pixel being a minimum unit for display of the image 24. For example, the pixel may include a red self-emitting element, a green self-emitting element, and a blue self-emitting element. In this case, in the control method of the display device 1 described above, in step S4, the display control unit 3 may move the position of the image 24 by one pixel or two pixels or more in the vertical direction or the horizontal direction of the display panel 2.

In the present embodiment, the example is described in which the display on the display panel 2 is repeatedly changed to the display illustrated in the schematic view 61, the schematic view 62, the schematic view 63, and the schematic view 64, but the present embodiment is not limited thereto. For example, the control unit 5 may change the above-described display on the display panel 2 in the reverse order. Further, the display panel 2 may display the image 24 at the center of the display portion 21, in other words, the black display region 25 may be formed at the entire periphery of the image 24.

The display control unit 3 may cause all of the self-light-emitting elements 23 of the display panel 2 to emit light and extract and display part of the image 24. In this case, the display control unit 3 may change the display position of the image 24 caused to be displayed on the display panel 2 by changing the portion of the image 24 to be caused to be displayed. In this case, the black display region 25 is not formed on the display panel 2, and thus the display device 1 can display an image with higher definition without changing the number of the light-emitting elements.

When the viewing sensor 4 detects states of a plurality of the users, the viewing sensor 4 may detect the non-viewing state based on a state of a user who is close to the center of the display portion 21 in a plan view of the display panel 2. For example, when the plurality of users are included in the captured image obtained by the camera 41, the viewing sensor 4 may detect the non-viewing state based on a state of a user closest to the center of the captured image.

A user located on an end portion side of the display portion 21 in a plan view of the display panel 2 is farther from the display panel 2 and has a larger difference between a direction viewing the image 24 and a display direction of the display panel 2 than a user located on a center portion side. Thus, the user located on the end portion side of the display portion 21 in a plan view of the display panel 2 is less likely to perceive the change in the display position of the image 24 than the user located on the center portion side. Thus, with the above-described configuration, the display device 1 can reduce the deterioration of the viewability of the image 24 by the plurality of users while reducing the image sticking of the self-light-emitting element 23.

### Second Embodiment

### Fixing of Display Position of Image

Another embodiment of the disclosure will be described below. Further, members having the same functions as those of the members described in the above-described embodiments will be denoted by the same reference numerals and signs, and the description thereof will not be repeated for the sake of convenience of description.

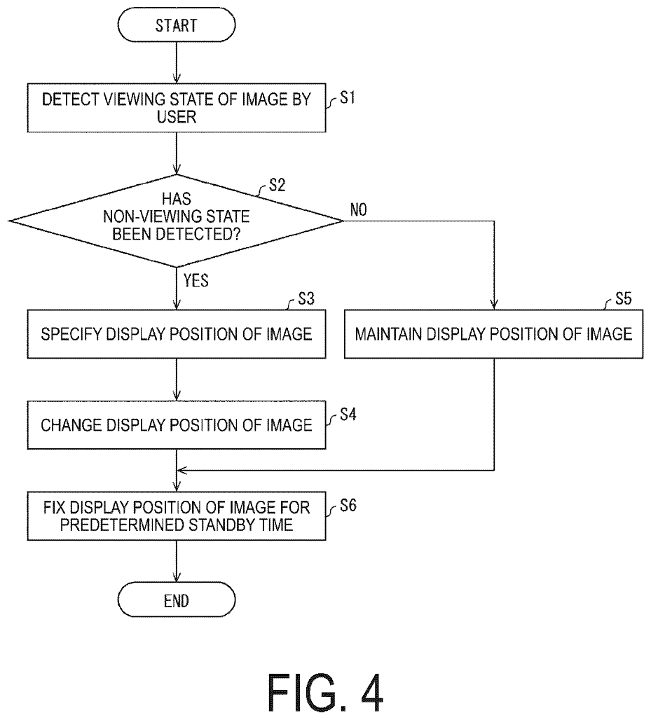

The display device 1 according to the present embodiment has the same configuration as that of the display device 1 according to the previous embodiment. A control method of the display device 1 according to the present embodiment is different in only part from the control method of the display device 1 according to the previous embodiment. The control method of the display device 1 according to the present embodiment will now be described with reference to FIG. 4. FIG. 4 is a flowchart illustrating an example of the control method of the display device 1 according to the present embodiment.

In the control method of the display device 1 according to the present embodiment, subsequent to step S4 and step S5 described in the previous embodiment, the control unit 5 causes the display control unit 3 to fix the display position of the image 24 on the display panel 2 for a predetermined standby time (step S6). During execution of step S6, in other words, until at least a predetermined standby time elapses from the start of execution of step S6, the control unit 5 fixes the display position of the image 24 on the display panel 2 regardless of whether the non-viewing state is detected by the viewing sensor 4.

After completion of step S6, in other words, after elapse of the predetermined standby time from the start of execution of step S6, the control unit 5 may execute step S1. As described above, the control unit 5 repeatedly executes steps S1 to S6. Thus, the control unit 5 changes the display position of the image 24 on the display panel 2 when the viewing sensor 4 detects the non-viewing state after the predetermined standby time has elapsed since the display position of the image 24 on the display panel 2 has changed last time.

In general, there is a variation in the interval at which the non-viewing state is detected, such as the interval between blinks of the user or the interval at which the user confirms the surroundings of the display device 1. However, according to the control method of the display device 1 according to the present embodiment, the control unit 5 does not change the display position of the image 24 on the display panel 2 until the predetermined standby time elapses since the display position has changed last time. Thus, even when there is variation in the interval at which the non-viewing state is detected, the display device 1 can reduce variation in the interval at which the display position of the image 24 is changed. Thus, the display device 1 according to the present embodiment, further equalize the light emission times of the respective self-light-emitting elements 23 and further efficiently reduce the image sticking of the respective self-light-emitting elements 23.

The control unit 5 may stop the operation of the viewing sensor 4 during at least part of the period during which step S6 is executed, in other words, during at least part of the period during which the display position of the image 24 on the display panel 2 is fixed by the display control unit 3. Thus, the display device 1 can achieve power saving in the period in which the operation of the viewing sensor 4 is stopped, and can simplify the control of the viewing sensor 4 by the control unit 5.

### Third Embodiment

### Duration Time of Non-Viewing State

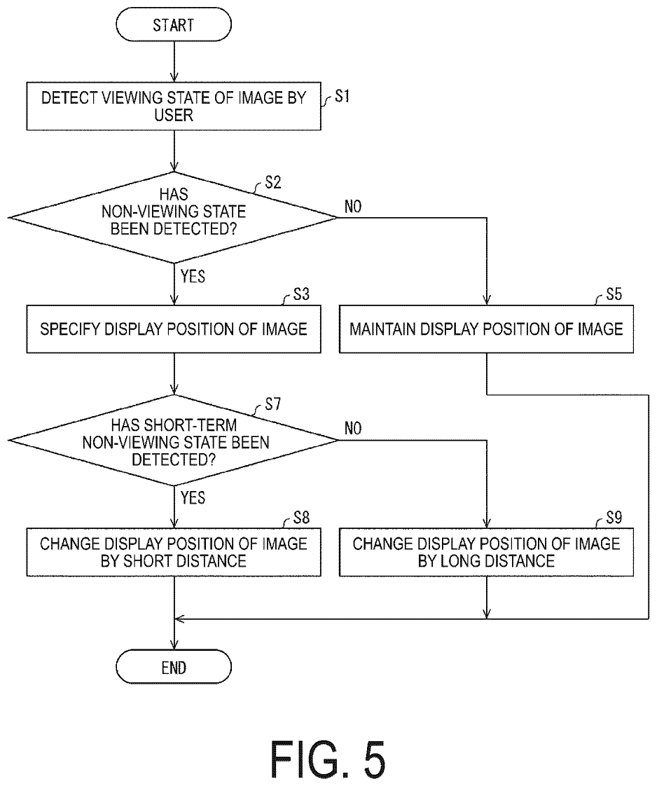

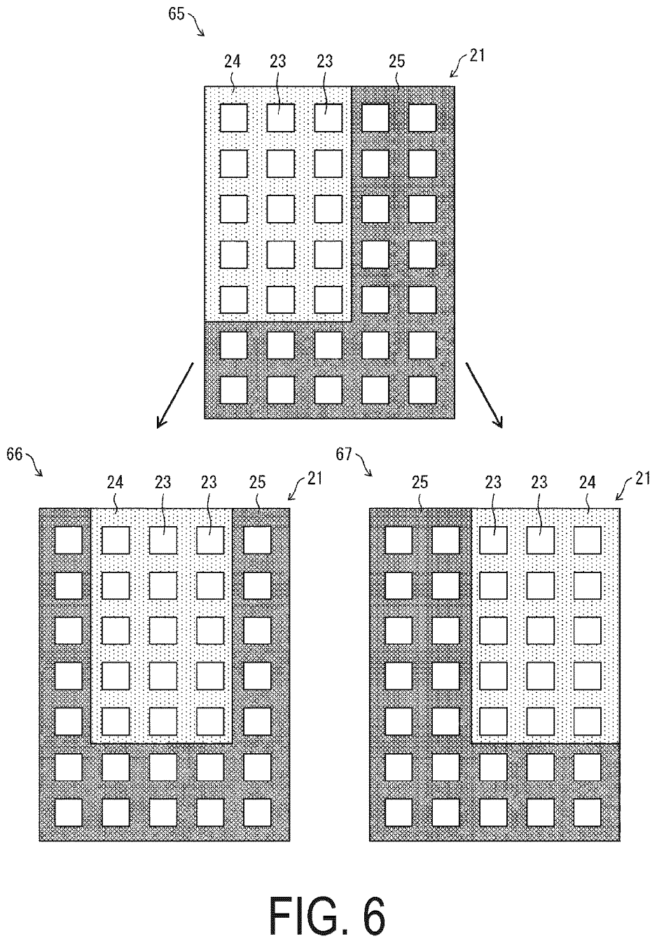

The display device 1 according to the present embodiment has the same configuration as that of the display device 1 according to any one of the above-described embodiments. The control method of the display device 1 according to the present embodiment is different in only part from the control method of the display device 1 according to any one of the above-described previous embodiments. The control method of the display device 1 according to the present embodiment will now be described with reference to FIGS. 5 and 6.

FIG. 5 is a flowchart illustrating an example of the control method of the display device 1 according to the present embodiment. FIG. 6 is a schematic view of the display portion 21 for illustrating an example of the display position of the image 24 on the display panel 2 according to the present embodiment. FIG. 6 illustrates schematic views of the display portion 21 in a state where the display panel 2 displays the image 24 as illustrated in schematic views 65, 66, and 67 in which the display positions of the image 24 on the display panel 2 are different from each other.

At the start of the control method of the display device 1 according to the present embodiment, it is assumed that the control unit 5 causes the display panel 2 to display the image 24 as illustrated in the schematic view 65 of FIG. 6. In this case, as illustrated in the schematic view 65, the image 24 is displayed at the upper left of the display portion 21, and the black display region 25 is formed at the right end portion and the lower end portion of the display portion 21. In particular, when the display panel 2 displays the image 24 as illustrated in the schematic view 65, two columns of the self-light-emitting elements 23 located at the right end portion of the display portion 21 and two rows of the self-light-emitting elements 23 located at the lower end portion do not emit light.

In the control method of the display device 1 according to the present embodiment, first, the control unit 5 executes steps S1 and S2 described above. If the control unit 5 determines that the viewing sensor has detected the non-viewing state in step S2, then the control unit 5 executes step S3 described above.

Subsequently, the control unit 5 determines whether the viewing sensor 4 has detected a short-term non-viewing state based on the viewing state detected by the viewing sensor 4 in step S1 (step S7).

In the present embodiment, the short-term non-viewing state is a state in which the viewing sensor 4 estimates that the time until the end of the non-viewing state is less than a predetermined time at the time point when the non-viewing state is detected by the viewing sensor 4. In other words, the short-term non-viewing state includes a state in which it can be estimated that the user returns to the state of viewing the image 24 again in less than the predetermined time at the time point when the non-viewing state is detected by the viewing sensor 4.

For example, the short-term non-viewing state includes a state in which it is estimated that the user is not viewing the image 24 by blinking. In addition, for example, the short-term non-viewing state includes a state in which it is estimated that the degree of viewing the image 24 is temporarily reduced by the user viewing the vicinity of the periphery of the image 24.

For example, when the viewing sensor 4 detects a state in which the eyelid of the user is closed as the non-viewing state by analyzing the captured image, the viewing sensor 4 estimates that the user blinks, and estimates that the non-viewing state is the short-term non-viewing state. In addition, when the viewing sensor 4 detects a state in which the viewpoint of the user is located in the vicinity of the periphery of the image 24 as the non-viewing state by analyzing the captured image, the viewing sensor 4 estimates that the non-viewing state is the short-term non-viewing state.

If the control unit 5 determines that the viewing sensor has detected the short-term non-viewing state in step S7, then the control unit 5 causes the display control unit 3 to change the display position of the image 24 on the display portion 21 by a short distance based on the display position of the image 24 on the display portion 21 (step S8).

For example, when the display panel 2 displays the image 24 as illustrated in the schematic view 65 in step S3, the control unit 5 causes the display panel 2 to display the image 24 as illustrated in the schematic view 66 in step S8 through the control of the display control unit 3. In other words, in step S8, the control unit 5 moves the display position of the image 24 on the display panel 2 to the right by only one column of the self-light-emitting elements 23 in a plan view of the display panel 2.

If the control unit 5 determines that the viewing sensor has not detected the short-term non-viewing state in step S7, then the control unit 5 determines that the viewing sensor has detected a long-term non-viewing state.

In the present embodiment, the long-term non-viewing state is a state in which the viewing sensor 4 estimates that the time until the end of the non-viewing state is equal to or greater than the predetermined time at the time point when the non-viewing state is detected by the viewing sensor 4. In other words, the long-term non-viewing state includes a state in which it can be estimated that a state in which the user does not view the image 24 continues for the predetermined time or more at the time point when the non-viewing state is detected by the viewing sensor 4. For example, the long-term non-viewing state includes a state in which it is estimated that the user confirms the surroundings of the display device 1. For example, when the viewing sensor 4 detects a state in which the viewpoint of the user is away from the image 24 by a predetermined distance or more as the non-viewing state by analyzing the captured image, the viewing sensor 4 estimates that the non-viewing state is the long-term non-viewing state.

If the control unit 5 determines that the viewing sensor has detected the long-term non-viewing state in step S7, then the control unit 5 causes the display control unit 3 to change the display position of the image 24 on the display panel 2 by a long distance based on the display position of the image 24 on the display panel 2 (step S9).

For example, when the display panel 2 displays the image 24 as illustrated in the schematic view 65 in step S3, the control unit 5 causes the display panel 2 to display the image 24 as illustrated in the schematic view 67 in step S9 through the control of the display control unit 3. In other words, in step S9, the control unit 5 moves the display position of the image 24 on the display panel 2 to the right by two columns of the self-light-emitting elements 23 in a plan view of the display panel 2.

Thus, in step S9, the control unit 5 changes the display position of the image 24 on the display panel 2 by a longer distance than the distance by which the display position is changed in step S8. Note that the change distance of the display position of the image 24 in the disclosure may be, for example, a distance from the center of the image 24 before the display position is changed to the center of the image 24 after the display position is changed.

If the control unit 5 determines that the viewing sensor has not detected the non-viewing state in step S2, then the control unit 5 executes step S5. Subsequent to step S5, S8, or S9, the control unit 5 may execute step S1 again, or may execute step S6 described above. As described above, the control unit 5 repeatedly executes each step illustrated in FIG. 5.

In steps S8 and S9, a moving direction of the image 24 may be determined in accordance with the display position of the image 24 on the display panel 2 specified in step S3. For example, when the display panel 2 displays the image 24 as illustrated in the schematic view 66 in step S3, the control unit 5 may cause the display panel 2 to display the image 24 as illustrated in the schematic view 67 in step S8. Alternatively, when the display panel 2 displays the image 24 as illustrated in the schematic view 66 in step S3, the control unit 5 may cause the display panel 2 to execute display in which the image 24 is moved further downward than the display illustrated in the schematic view 67 in step S9.

In general, when the period during which the user does not view the image 24 on the display panel 2 is short and the display position of the image 24 is largely changed after the user views the image 24 last time, the user who newly views the image 24 is likely to perceive the change in the display position of the image 24. On the other hand, even when the user does not view the image 24 on the display panel 2 for a long time and the display position of the image 24 is largely changed after the user views the image 24 last time, the user who newly views the image 24 is less likely to perceive the change in the display position of the image 24.

The display device 1 according to the present embodiment changes the display position of the image 24 by a short distance when detecting the short-term non-viewing state in which the user is likely to perceive the change in the display position of the image 24. In addition, the display device 1 changes the display position of the image 24 by a long distance when detecting the long-term non-viewing state in which the user is less likely to perceive the change in the display position of the image 24. Thus, the display device 1 can further efficiently achieve both the suppression of the perception of the change in the display position of the image 24 by the user and the reduction of the image sticking of the respective self-light-emitting elements 23.

In the present embodiment, the control unit 5 moves the display position of the image 24 by one element in step S8 and by two elements in step S9, but the present embodiment is not limited thereto. As long as the display position of the image 24 is changed by a longer distance in step S9 than in step S8, the changing method of the display position of the image 24 by the control unit 5 in the present embodiment is not particularly limited.

### Fourth Embodiment

Degree of viewing Image

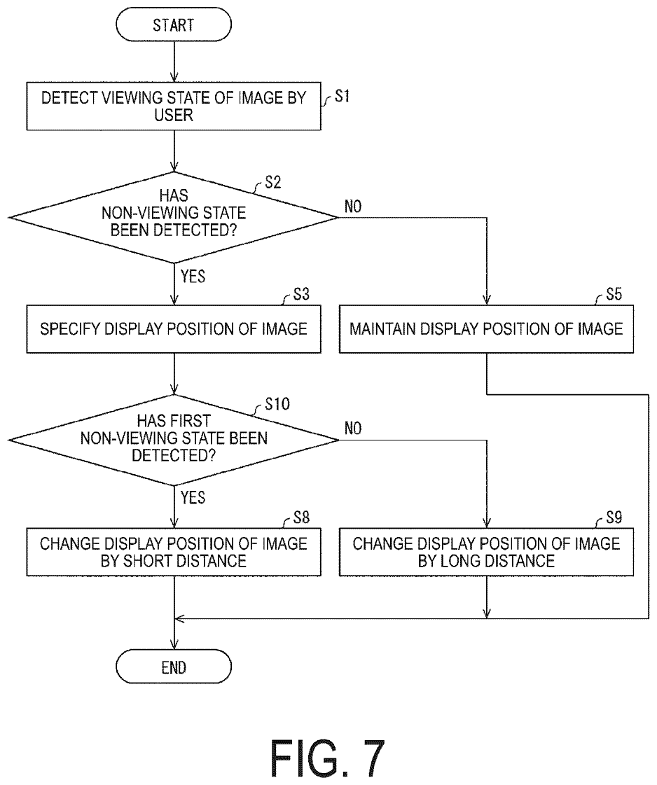

The display device 1 according to the present embodiment has the same configuration as that of the display device 1 according to any one of the above-described embodiments. The control method of the display device 1 according to the present embodiment is different in only part from the control method of the display device 1 according to any one of the above-described previous embodiments. The control method of the display device 1 according to the present embodiment will now be described with reference to FIG. 7. FIG. 7 is a flowchart illustrating an example of the control method of the display device 1 according to the present embodiment.

In the control method of the display device 1 according to the present embodiment, first, the control unit 5 executes steps S1 and S2 described above. If the control unit 5 determines that the viewing sensor has detected the non-viewing state in step S2, then the control unit 5 executes step S3 described above.

Subsequently, the control unit 5 determines whether the viewing sensor 4 has detected a first non-viewing state based on the viewing state detected by the viewing sensor 4 in step S1 (step S10).

In the present embodiment, the first non-viewing state is a state in which the viewing sensor 4 estimates that the image 24 is located in part of the field of view of the user. In other words, the first non-viewing state includes a state in which although the degree of viewing the image 24 by the user is low and the state is the non-viewing state, it can be estimated that the image 24 does not completely move out of the field of view of the user and the image 24 remains in part of the field of view of the user. For example, the viewing sensor 4 detects that a distance between the viewpoint of the user and the center of the image 24 is less than a predetermined distance by analyzing the captured image to detect the first non-viewing state.

If the control unit 5 determines that the viewing sensor has detected the first non-viewing state in step S10, then the control unit 5 executes step S8 described above. For example, when the display panel 2 displays the image 24 as illustrated in the schematic view 65 in step S3, the control unit 5 causes the display panel 2 to display the image 24 as illustrated in the schematic view 66 in step S8 through the control of the display control unit 3.

If the control unit 5 determines that the viewing sensor has not detected the first non-viewing state in step S10, then the control unit 5 determines that the viewing sensor has detected a second non-viewing state.

In the present embodiment, the second non-viewing state is a state in which the viewing sensor 4 estimates that the image 24 is located outside the field of view of the user. In other words, the second non-viewing state includes a state in which it can be estimated that the image 24 is completely moved out of the field of view of the user and the image 24 does not remain in the field of view of the user. For example, the viewing sensor 4 detects that a distance between the viewpoint of the user and the center of the image 24 is equal to or greater than the predetermined distance by analyzing the captured image to detect the second non-viewing state.

If the control unit 5 determines that the viewing sensor has detected the second non-viewing state in step S10, then the control unit 5 executes step S9 described above. For example, when the display panel 2 displays the image 24 as illustrated in the schematic view 65 in step S3, the control unit 5 causes the display panel 2 to display the image 24 as illustrated in the schematic view 67 in step S9 through the control of the display control unit 3.

If the control unit 5 determines that the viewing sensor has not detected the non-viewing state in step S2, then the control unit 5 executes step S5. Subsequent to step S5, S8, or S9, the control unit 5 may execute step S1 again, or may execute step S6 described above. As described above, the control unit 5 repeatedly executes each step illustrated in FIG. 7.

In general, even in the non-viewing state, when the image 24 remains in part of the field of view of the user and the display position of the image 24 is largely changed, the user is likely to perceive the change in the display position of the image 24. On the other hand, in a state where the image 24 is moved out of the field of view of the user, even when the display position of the image 24 is largely changed, the user is less likely to perceive the change in the display position of the image 24.

The display device 1 according to the present embodiment changes the display position of the image 24 by a short distance when detecting the first non-viewing state in which the user is likely to perceive the change in the display position of the image 24. In addition, the display device 1 changes the display position of the image 24 by a long distance when detecting the second non-viewing state in which the user is less likely to perceive the change in the display position of the image 24. Thus, the display device 1 can further efficiently achieve both the suppression of the perception of the change in the display position of the image 24 by the user and the reduction of the image sticking of the respective self-light-emitting elements 23.

In the present embodiment, the control unit 5 may execute step S7 described above before or after step S10. For example, the control unit 5 may execute step S7 prior to step S10. In this case, for example, if the short-term non-viewing state is detected in step S7, then the control unit 5 may execute step S8 without executing step S10. Alternatively, the control unit 5 may execute step S7 subsequent to step S10. In this case, for example, even if the second non-viewing state is detected in step S10, then the control unit 5 may execute step S8 when the short-term non-viewing state is detected in step S7.

For example, when the user blinks, the short-term non-viewing state is detected in step S7, whereas the image 24 does not exist in the field of view of the user, and thus the second non-viewing state is detected in step S10. When the short-term non-viewing state is detected, the user enters a state of viewing the image 24 again in less than the predetermined time regardless of whether the image 24 is located in the field of view. In this case, even when the second non-viewing state is detected in step S10 the user may perceive the change in the display position of the image 24 when the display position of the image 24 is changed by a long distance.

With the above configuration, even when the second non-viewing state is detected in step S10, the display device 1 changes the display position of the image 24 by a short distance when the period of the non-viewing state of the user is less than the predetermined time. Thus, the display device 1 can further efficiently suppress the perception of the change in the display position of the image 24 by the user.

### Fifth Embodiment

### Frequency of Non-Viewing State

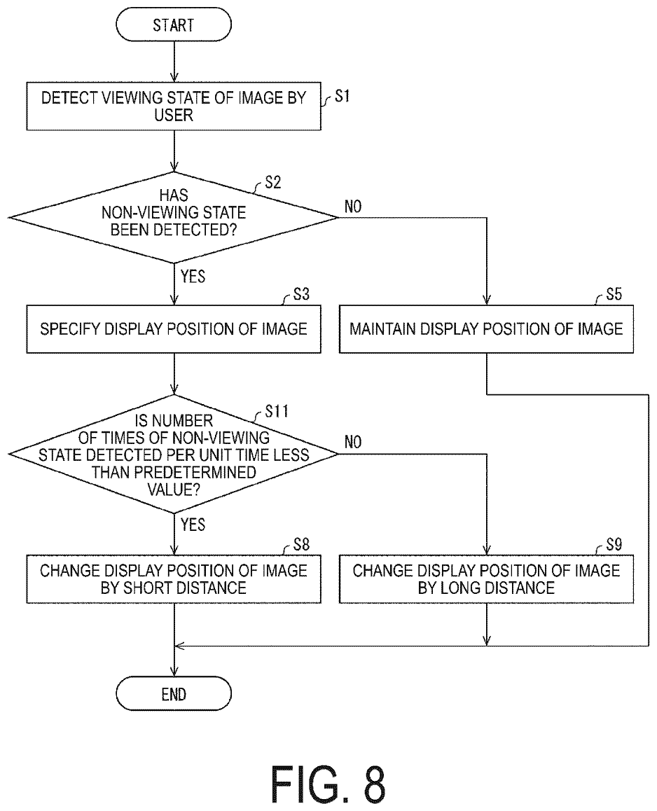

The display device 1 according to the present embodiment has the same configuration as that of the display device 1 according to any one of the above-described embodiments. The control method of the display device 1 according to the present embodiment is different in only part from the control method of the display device 1 according to any one of the above-described previous embodiments. The control method of the display device 1 according to the present embodiment will now be described with reference to FIG. 8. FIG. 8 is a flowchart illustrating an example of the control method of the display device 1 according to the present embodiment.

In the control method of the display device 1 according to the present embodiment, first, the control unit 5 executes steps S1 and S2 described above. If the control unit 5 determines that the viewing sensor has detected the non-viewing state in step S2, then the control unit 5 executes step S3 described above.

Subsequently, the control unit 5 determines whether the number of times of the non-viewing state detected by the viewing sensor 4 per unit time is less than a predetermined value (step S11). The control unit 5 may record, for example, the number of times of execution of step S3. The number of times of the non-viewing state detected by the viewing sensor 4 per unit time may be calculated from the number of times of execution of step S3 during a predetermined time period.

If the control unit 5 determines that the number of times of the non-viewing state detected by the viewing sensor 4 per unit time in step S11 is less than the predetermined value, then the control unit 5 executes step S8 described above. If the control unit 5 determines that the number of times of the non-viewing state detected by the viewing sensor 4 per unit time in step S11 is equal to or greater than the predetermined value, then the control unit 5 executes step S9 described above. If the control unit 5 determines that the viewing sensor has not detected the non-viewing state in step S2, then the control unit 5 executes step S5. Subsequent to step S5, S8, or S9, the control unit 5 may execute step S1 again, or may execute step S6 described above. As described above, the control unit 5 repeatedly executes each step illustrated in FIG. 8.

In general, when the number of times of the non-viewing state per unit time is small, it is assumed that the user is concentrating on viewing the image 24, for example, the frequency of blinking of the user is low, or the user does not turn the line of sight off the image 24. In this case when the display position of the image 24 is largely changed, the user is likely to perceive the change in the display position of the image 24.

On the other hand, when the number of times of the non-viewing state per unit time is large, it is assumed that the user does not concentrate on viewing the image 24, for example, the frequency of blinking of the user is high, or the user frequently turns the line of sight off the image 24. In this case, even when the display position of the image 24 is largely changed, the user is less likely to perceive the change in the display position of the image 24.

The display device 1 according to the present embodiment changes the display position of the image 24 by a short distance when it is estimated that the user is concentrating on viewing the image 24. The display device 1 changes the display position of the image 24 by the long distance when it is estimated that the user is not concentrating on viewing the image 24. Thus, the display device 1 can further efficiently achieve both the suppression of the perception of the change in the display position of the image 24 by the user and the reduction of the image sticking of the respective self-light-emitting elements 23.

The control unit 5 according to each embodiment of the disclosure may be implemented by a computer. A control program of the display device 1 for causing a computer to implement the control unit 5 according to each embodiment of the disclosure and a computer-readable recording medium in which the control program is recorded also fall within the scope of the disclosure.

For example, the display device 1 may include a computer including at least one control device including, for example, a processor and at least one storage device including, for example, a non-volatile memory, as hardware for executing the program. By executing the program by using the control device and the storage device, each function described in the above-described each embodiment may be implemented.

The program may be stored in a non-transitory and computer readable one or a plurality of recording media. The display device 1 may include or need not include the recording medium. In the latter case, the program may be supplied to the display device 1 via any wired or wireless transmission medium.

Furthermore, some or all of the functions of the control unit 5 can be achieved by a logic circuit. For example, an integrated circuit, in which a logic circuit functioning as at least part of the control unit 5 is formed, is also included within the scope of the disclosure. In addition, it is also possible to implement the function of the control unit 5 by, for example, quantum computers.

In addition, each process described in each embodiment may be executed by artificial intelligence (AI). In this case, the AI may be operated by the control device, or may be operated by another device (for example, an edge computer or a cloud server).

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in each of the embodiments.

### REFERENCE SIGNS LIST

1 Display device
2 Display panel
3 Display control unit
4 Viewing sensor
5 Control unit
23 Self-light-emitting element
24 Image
41 Camera
42 Captured image analysis unit

1. A display device comprising:
a display panel including a plurality of self-light-emitting elements;
a display control unit configured to individually control light emission of the plurality of self-light-emitting elements to control display of an image on the display panel; and
a viewing sensor configured to detect, from a state of a user, a non-viewing state that is a state in which the user does not view a display screen, a state in which a line of sight of the user does not intersect the display screen, or a state in which a distance between a viewpoint of the user on the display screen and a position of the image is equal to or greater than a predetermined value,
wherein the display control unit changes a display position of at least part of the image on the display panel through control of light emission of the plurality of self-light-emitting elements when the viewing sensor detects the non-viewing state.

2. The display device according to claim 1,
wherein the display control unit changes a display position of the entire image on the display panel when the viewing sensor detects the non-viewing state.

3. The display device according to claim 1,
wherein the viewing sensor detects at least a short-term non-viewing state in which a time until an end of the non-viewing state is estimated to be less than a predetermined time at a time point of detection of the non-viewing state and a long-term non-viewing state in which a time until the end of the non-viewing state is estimated to be equal to or greater than a predetermined time at the time point of detection of the non-viewing state, and
the display control unit changes the display position by a longer distance when the viewing sensor detects the long-term non-viewing state than when the viewing sensor detects the short-term non-viewing state.

4. The display device according to claim 1,
wherein the viewing sensor detects at least a first non-viewing state in which the image is estimated to be located in part of a field of view of the user and a second non-viewing state in which the image is estimated to be located outside the field of view of the user, and
the display control unit changes the display position by a longer distance when the viewing sensor detects the second non-viewing state than when the viewing sensor detects the first non-viewing state.

5. The display device according to claim 1,
wherein the display control unit changes the display position by a longer distance when the number of times of the non-viewing state detected by the viewing sensor per unit time is equal to or greater than a predetermined value than when the number of times is less than the predetermined value.

6. The display device according to claim 1,
wherein the non-viewing state includes a state in which an eyelid of the user is closed.

7. The display device according to claim 1,
wherein the non-viewing state includes a state in which a viewpoint of the user is located at a periphery of the image.

8. The display device according to claim 1,
wherein, after changing the display position, the display control unit fixes the display position for at least a predetermined standby time or longer regardless of whether the non-viewing state is detected.

9. The display device according to claim 8,
wherein an operation of the viewing sensor is stopped in at least part of a period during which the display position is fixed by the display control unit.

10. The display device according to claim 1,
wherein the viewing sensor includes
a camera configured to capture an image of the user, and
a captured image analysis unit configured to detect the non-viewing state from the captured image obtained by the camera.

11. A control method of a display device including a display panel including a plurality of self-light-emitting elements, the control method comprising:
controlling display of an image on the display panel through individual control of light emission of the plurality of self-light-emitting elements;
detecting, based on a state of a user, a non-viewing state that is a state in which the user does not view a display screen, a state in which a line of sight of the user does not intersect the display screen, or a state in which a distance between a viewpoint of the user on the display screen and a position of the image is equal to or greater than a predetermined value; and
changing a display position of at least part of the image on the display panel through control of light emission of the plurality of self-light-emitting elements when the non-viewing state is detected.
